(19) United States
(12) Patent Application Publication
(10) Pub. No.: US 2023/0038977 A1
(43) Pub. Date: Feb. 9, 2023

(54) APPARATUS AND METHOD FOR PREDICTING ANOMALOUS EVENTS IN A SYSTEM

(71) Applicant: Peakey Enterprise LLC, Warsaw, IN (US)

(72) Inventors: Brandon Ditto, Warsaw, IN (US); Randall Hankins, Warsaw, IN (US)

(73) Assignee: Peakey Enterprise LLC, Warsaw, IN (US)

(21) Appl. No.: 17/879,831

(22) Filed: Aug. 3, 2022

Related U.S. Application Data
(60) Provisional application No. 63/230,091, filed on Aug. 6, 2021.

(51) Int. Cl. G06F 11/07; G06F 11/34

(52) U.S. Cl. CPC G06F 11/0793; G06F 11/3447; G06F 11/0769

(57) ABSTRACT

A method and apparatus are described. The method includes receiving a set of data streams including data values generated by a sensor associated with the operation of a component in a system at points in time and generating an anomaly data value for the received data values. The method further includes applying a machine learning algorithm to the received data values and a subset of data values previously received to generate expected data values at points in time beyond the current point in time, generating an expected anomaly data value for each of the expected data values, and identifying an operational anomaly for the component at a point in time beyond the current time based on the expected anomaly data value. The apparatus includes an input interface for receiving the data streams and a processor for processing the received data values to identify an operational anomaly as described above.

### CROSS-REFERENCE TO RELATED APPLICATION

This application claims the benefit, under 35 U.S.C. § 119(e), of U.S. Provisional Patent Application 63/230,091, filed on Aug. 6, 2021, which is incorporated herein in its entirety.

### TECHNICAL FIELD

The present disclosure generally relates to the field of failure detection in systems and more particularly towards identifying anomalous events in an element, such as a component, of a system in order to mitigate or prevent failure in the system.

### BACKGROUND

Any background information described herein is intended to introduce the reader to various aspects of art, which may be related to the present embodiments that are described below. This discussion is believed to be helpful in providing the reader with background information to facilitate a better understanding of the various aspects of the present disclosure. Accordingly, it should be understood that these statements are to be read in this light.

Data analytics and data science, and the use of machine learning and artificial intelligence (AI), are among the hottest new technical achievements available to businesses today. Various forms of data analytics can be found in almost all aspects of life, including media content recommendations, shopping, and sporting events, along with business and manufacturing activities. In general, the process of applying data analytics often relies on several elements for proper use. A mechanism is required for collecting data values. These data values may be directly available, such as user inputs, or may be more indirectly available, such as values provided by sensors on electrical and/or mechanical devices. A processing device, such as a computer or server, is usually necessary to perform some type of process or algorithm to manipulate the data values into the developed outcome as part of the data analysis. Further, a data storage mechanism is needed to store current as well as past data values that may be used as part of the process or algorithm. Finally, a mechanism is required to convey the developed outcome to where it is needed for use.

Several important business and technology areas that may benefit from the use of data analytics include the manufacturing and materials processing sectors, as well as the communications sectors. For companies in these sectors, downtime or outages can be very disruptive, particularly when the downtime or outages are not planned. While all companies experience and utilize planned downtime to take care of maintenance and other shutdown related activities, unplanned downtime is both unexpected and undesired. Recent research indicates that 82 percent of companies, including those in the sectors mentioned above, have experienced unplanned downtime over the past three years and that unplanned downtime can cost a company as much as $260,000 an hour, with the average downtime or outage lasting four hours. The unplanned downtime meant that those companies could not deliver products or services to customers, lost production time on a critical asset, or were totally unable to service or support specific equipment or assets.

Degradation, failure, and other catastrophic events (collectively “events”) can currently be predicted on a limited basis using data from one or more sensors and applying data analytics techniques to predict a single data forecast or projection (mathematical formula). While these projections may show changes in characteristics or behavior that is expected based on the data, they are not robust enough in many applications to predict unexpected events. Unexpected events are commonly referred to as anomalous events. If the projections can predict these anomalous events, preventative and other measures may be taken to increase safety, reliability, and efficiency.

However, the ability to accurately predict anomalies using data analytics has remained elusive. Many machine learning algorithms do not forecast or project anomalies accurately, even when using data from more than one sensor. The forecasts or projections begin to diverge immediately from reality as these models fail to include the impact each sensor may have on the others. In some cases, data analytics processes may include an anomaly identifier mechanism or anomaly detector. Anomaly detectors are employed to automatically detect unexpected data within data streams. However, the anomaly identifier mechanisms can only identify occurrences that have been detected and identified as anomalous and may even be perceived as anomalous by a human non-expert. But when examined closely by a trained professional the otherwise anomalous behavior is predictable or normal behavior based on, for instance, a wider array of inputs from a particular set of dependent elements. These occurrences may be referred to as false anomalies. The presence of false anomalies in the data set hinder most data analytics processes from being able to accurately predict anomalies without also further including the prediction of false anomalies.

As was described above, it is possible to improve the anomaly detection capability of most data analytics processes by augmenting the algorithm with assistance from a human expert or trained professional. The trained professional analyzes the past and current data to identify and remove or re-label the false anomalies as not anomalous, effectively cleaning the past data of false anomalies and leaving only true anomalies in the data set. However, the inclusion of human assistance in what is expected to be an AI machine learning process is both costly and time consuming. Further, the analysis of current and past data by the trained professional may not be timely enough to provide the ability to update or modify the machine learning algorithms to improve the prediction of future anomalies before they actually occur and, in some cases, to identify or predict some future anomalies at all. As a result, there is a need for an improved data analytics mechanism that is capable of predicting false anomalies in order to improve the accuracy of predicting true anomalies without requiring additional human interaction.

### SUMMARY

These and other drawbacks and disadvantages presented by mechanisms that are used for predicting anomalous events in a system are addressed by the principles of the present disclosure. However, it can be understood by those skilled in the art that the present principles may offer advantages in other types of devices and systems as well.

According to an implementation, a method is described. The method includes receiving a set of data streams, each data stream including data values generated by a sensor associated with the operation of a component in a system at points in time and generating an anomaly data value for each of the received data values in each data stream. The method further includes applying at least one machine learning algorithm to the data values received at a current point in time and a subset of data values previously received for each data stream to generate expected data values at additional points in time beyond the current point in time for each data stream, generating an expected anomaly data value for each of the expected data values in each data stream, and identifying an operational anomaly for the component at a point in time beyond the current point in time based on the expected anomaly data value for each of the expected data values in each data stream.

According to an implementation, an apparatus is described. The apparatus includes an input interface that receives a set of data streams, each data stream including data values generated by a sensor associated with the operation of a component in a system at points in time. The apparatus further includes a processor coupled to the input interface. The processor is configured to determine an anomaly data value for each of the received data values in each data stream, apply a machine learning algorithm to the received data values at a current point in time and a subset of data values previously received for each data stream to generate expected data values at additional points in time past the current point in time for each data stream, determine an expected anomaly data value for each of the expected data values for each data stream, and identify an operational anomaly of the component at a point in time past the current point in time based on the expected anomaly data value for each of the expected data values for each data stream.

According to an implementation, a non-transitory computer readable medium is described. The non-transitory computer readable medium has stored thereon instructions that, when executed by at least one processor, perform the steps of receiving a set of data streams, each data stream including data values generated by a sensor associated with the operation of a component in a system at points in time, generating an anomaly data value for each of the received data values in each data stream, applying at least one machine learning algorithm to the data values received at a current point in time and a subset of data values previously received for each data stream to generate expected data values at additional points in time beyond the current point in time for each data stream, generating an expected anomaly data value for each of the expected data values in each data stream, and identifying an operational anomaly for the component at a point in time beyond the current point in time based on the expected anomaly data value for each of the expected data values in each data stream.

### BRIEF DESCRIPTION OF THE DRAWINGS

The above and other aspects, features, and advantages of the present disclosure will become more apparent in light of the following detailed description when taken in conjunction with the accompanying drawings in which:

FIG. 1 is a block diagram of an exemplary embodiment of a portion of a system that includes sensor and control capabilities to which the principles of the present disclosure are applicable;

FIG. 2 is a block diagram of an exemplary data processing device to which the principles of the present disclosure are applicable;

FIG. 3 is a block diagram of a core processing engine used in a data processing device to which the principles of the present disclosure are applicable;

FIG. 4 is a block diagram of a multivariate machine learning algorithm used as part of a core processing engine to which the principles of the present disclosure are applicable;

FIG. 5 is a block diagram of an anomaly detection and classification element used as part of a core processing engine to which the principles of the present disclosure are applicable;

FIG. 6 is a block diagram of an anomaly prediction and classification element used as part of a core processing engine to which the principles of the present disclosure are applicable;

FIG. 7 is a block diagram of a tuning algorithm element used as part of a core processing engine to which the principles of the present disclosure are applicable;

FIG. 8 is a flow chart of an exemplary process 800 for predicting anomalies in a system to which the principles of the present disclosure are applicable; and

FIG. 9 and FIG. 10 are graphs comparing the predictive data values to the received data values as processed by a core processing engine to which the principles of the present disclosure are applicable.

### DETAILED DESCRIPTION

The present disclosure may be applicable to various types of systems that may be affected by unanticipated or unexpected operational anomalies. Such systems may include, but are not limited to manufacturing, electrical, electronic, mechanical and electromechanical systems. The principles of the present disclosure may easily be extended to address issues in specific issues with other types of systems that are based on computer and/or communications systems, such as, but not limited to, financial systems, weather monitoring systems, and the like.

The present description illustrates the principles of the present disclosure. It will thus be appreciated that those skilled in the art will be able to devise various arrangements which, although not explicitly described or shown herein, embody the principles of the present disclosure and are included within the scope of the claims.

All examples and conditional language recited herein are intended for pedagogical purposes to aid the reader in understanding the principles of the present disclosure and the concepts contributed by the inventor(s) to furthering the art and are to be construed as being without limitation to such specifically recited examples and conditions.

Moreover, all statements herein reciting principles, aspects, and embodiments of the principles of the present disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the embodiments hereof, any element expressed or described, directly or indirectly, as a means for performing a specified function is intended to encompass any way of performing that function including, for example, a) a combination of elements that performs that function or b) any mechanism having a combination of electrical or mechanical elements to perform that function. The disclosure as defined by such claims resides in the fact that the functionalities provided by the various recited means are combined and brought together in the manner which the claims call for. It is thus regarded that any means that can provide those functionalities are equivalent to those shown herein.

It should be understood that the elements shown in the figures may be implemented in various forms of hardware, software, or combinations thereof. Preferably, these elements are implemented in a combination of hardware and software on one or more appropriately programmed general-purpose devices, which may include a processor, memory, and input/output interfaces. Herein, the phrase “coupled” is defined to mean directly connected to or indirectly connected with one or more intermediate components. Such intermediate components may include both hardware and software based components.

Thus, for example, it will be appreciated by those skilled in the art that the block diagrams presented herein represent conceptual views of illustrative system components and/or circuitry embodying the principles of the disclosure. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor”, “module” or “controller” should not be construed to refer exclusively to hardware capable of executing software, and may implicitly include, without limitation, a System on a Chip (SoC), digital signal processor (“DSP”) hardware, read only memory (“ROM”) for storing software, random access memory (“RAM”), and nonvolatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

The present embodiments address issues associated with applying machine learning techniques and data analytics to operational systems and devices that have operational anomalies during normal operation. The operational anomalies may require attention by an operator or technician, and in some cases, may force operation to cease resulting in unexpected downtime, or may even cause potentially catastrophic failure events, as described above. The operational anomaly may be identified by an operator or skilled technician when it occurs. However, the operator or skilled technician is not likely able to predict the presence of future anomalous behavior of components in the system that can lead to the operational anomaly. Applying traditional AI techniques through machine learning algorithms to anomaly detection and/or identification can lead to anomalies that are not actually anomalies when further evaluated by operator or skilled technician, referred to as “false anomalies”. These false anomalies are often generated or predicted by the algorithms since unexpected anomalies in data often cause issues in the algorithms. The predicted anomalies generated by the algorithms usually require additional review by a skilled technician in order separate the true anomalies from the false anomalies. The additional review is both expensive, time intensive, and potentially inefficient.

The present embodiments address the problems associated with improper or incorrect anomaly detection and/or identification (i.e., false anomalies) that can occur using the conventional machine learning techniques by forecasting or predicting the presence of these false anomalies. By identifying the presence of operational anomalies that have previously occurred, operational anomalies may be predicted in the future based on anomaly data values derived from the predicted data values from the sensors. Proactive actions may be taken to prevent unplanned downtime due to events that occur as a result of the operational anomaly. These proactive actions additionally increase safety, energy efficiency, and reliability in systems, such as manufacturing facilities and supply chains. The presence of operational anomalies in the future that may be false anomalies can also be identified to prevent unnecessary interruption to operations.

The present embodiments include anomaly detection and classification mechanisms that operate on both the received data from components in the system as well as the predictive or expected data for the components generated by machine learning algorithms processing the received data. The machine learning algorithm processes the received data in a multivariate fashion, using all of the received data from the components to generate the predictive or expected data for specific elements associated with the components. The anomaly information for the anomaly detection and classification mechanism that operates on the received data may be used to improve the operational anomaly prediction capability of the anomaly detection and classification mechanism that operates on the predictive or expected data. Further, the anomaly information from both anomaly detection and classification mechanism may be compared with the results of the comparison used to modify the machine learning algorithms. In this manner, the issues associated with identifying and separating false anomalies from the set of predicted anomalies is addressed by detecting anomalies on the predictive or expected output of a self-supervised multivariate machine learning algorithm. The mechanisms may extend to allow the machine learning algorithms to be more robust to any prediction task presented to the algorithms.

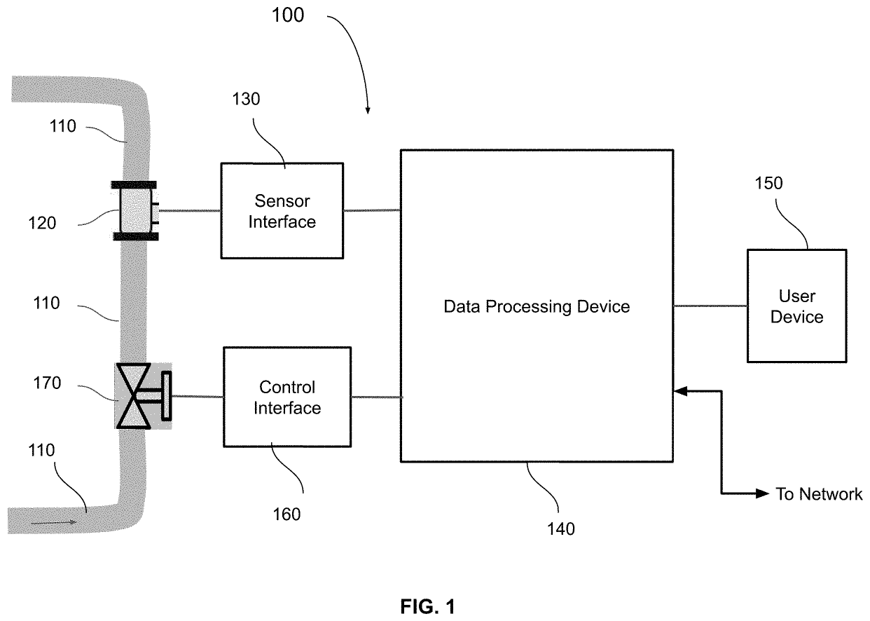

Turning now to FIG. 1, a block diagram of an exemplary embodiment of a portion of a system 100 that includes sensor and control capabilities according to aspects of the present disclosure is shown. System 100 includes sensor and control capabilities often found in many manufacturing facilities as well as many devices. System 100 may be incorporated into any electrical, mechanical, or electromechanical system or device that can benefit from and utilize data analytics to improve operation. Such a system may be utilized in conjunction with manufacturing equipment, such as fluid pumps, motors and the like, or communication devices, such as network computers, servers, routers, gateways, and the like. System 100 includes sections of pipe 110 used to contain some form of a fluid or gas as part of a larger fluid or gas flow system. The direction of flow of the fluid or gas is shown by an arrow. Two sections of pipe 110 are mechanically coupled to a sensor structure or meter 120. The sensor structure or meter 120 is coupled, electrically and/or mechanically, to a sensor interface 130. The sensor interface is electrically coupled to a data processing device 140. The data processing device 140 is electrically coupled to a control interface 160. The control interface is coupled, electrically and/or mechanically, to a flow control valve 170, which is also coupled to two sections of pipe 110. The data processing device 140 is also electrically coupled to a user device 150. A network connection for the data processing device 140 is also included. It is worth noting that some elements necessary for operation of system 100 are not shown as they are well known to those skilled in the art.

The sensor structure 120 monitors various characteristics of the flow of the fluid or gas through the pipes 110 as part of the overall operation of system 100. In order to monitor the various characteristics, a plurality of different types of sensors may be included in the sensor structure 120. The sensors may be used to monitor and generate data values associated with or related to the various characteristics. Examples of the types of sensors that may be used include but are not limited to, temperature sensors, rotational sensors, vibrational sensors, chemical sensors, accelerometers, flow rate sensors, pressure sensors and the like. In an embodiment, sensor structure 120 may include sensors to monitor flow rate of the fluid, voltage of the sensor, current drawn by the sensor, temperature of the fluid, temperature of the sensor, pressure of the fluid, acceleration of the sensor in a first direction and acceleration of the sensor in a second direction. In some embodiments, either the sensor structure 120 itself, or one or more of the individual sensors in sensor structure 120, may provide data values continuously or in a periodic manner. In some cases, either the sensor structure 120 itself, or one or more of the individual sensors, may provide data values only when requested, (e.g., by sensor interface 130).

The sensor interface 130 provides the electrical interface between the one or more sensors in the sensor structure 120 and an electronic signal processing device, such as data processing device 140. The sensor interface 130 may include an electrical or electromechanical property or characteristic conversion mechanism for one or more of the sensors. For example, the sensor interface 130 may include a conversion mechanism to convert the electrical voltage created by a vibrational or rotational sensor to a digital signal. Further, the sensor interface 130 may include a signal aggregator to allow the collection of a set of sensor signals from individual sensors in sensor structure 120 to be communicated as digital data values.

The data processing device 140 receives the data values from the sensor interface 140 through some type of local network connection. The local network connection may be a wired, such as ethernet or a local bus (e.g., inter-integrated circuit bus), or may be a wireless connection. The data processing device provides the signal and data processing capabilities and storage needed for maintaining current and past data values as well as producing any desired outcomes for characteristics of system 100. The data processing device 140 includes hardware circuits and/or software code for processing the signals and data values from the sensors to identify data anomalies in the data values. The data processing device 140 further includes machine learning hardware circuits and/or software code to generate predictive data values for additional data including data values beyond the current point in time. The predictive data values, often referred to as expected data values, may further be analyzed to identify data anomalies in the predictive values. The processing and analysis may include predicting an operational anomaly that will require attention before the anomaly forces a component or piece of equipment to fail or be taken out of operation. The identified data anomalies, including the data anomalies in the predictive data values, may be used as part of a fluid or gas flow control mechanism through control interface 160 and flow control valve 170. The data processing device 140 may include one or more processors, signal processors, arithmetic processors, and controllers for performing operations on the data values received from the sensor structure 120 through the sensor interface 130. The data processing device 140 may also include one or more types of memory or storage as well as a connection to an external network for communicating data value and/or results from processing to other elements in system 100, including user device 150. The data processing device 140 may also include various other more local interfaces for connecting auxiliary equipment, such as keyboards, display monitors, and the like. The data processing device 140 may further be embodied as a server, a desktop computer, a mainframe computer, and the like.

The control interface 160 receives control commands generated at the data processing device 140. The control commands may be generated based on the data values from the sensor structure 120 and processed through the sensor interface 130 and data processing device 140 in a manner similar to that described above. Additionally or alternatively, the control commands may be generated as a result of inputs from a user (e.g., an operator or technician) and provided to control interface 160 through data processing device 140. The user may provide inputs directly into the data processing device 140 or may provide inputs remotely, such as over a network or through the user device 150. The inputs from the user may be based on information associated with the data anomalies identified in the data processing device The control commands may include any changes to the operation of the flow control valve 170. For example, a control command may be sent to the flow control valve 170 from the data processing device 140 through the control interface 160 to alter the operational position of the flow control valve based on processed data values, such as identified operational anomaly information, associated with sensor structure 120.

It is worth noting that in some embodiments, some control commands may be generated in the data processing device 140 without further input from the user. The control commands may be generated automatically based on the data values from the sensor structure 120 as part of software programming instructions included in the data processing device 140. In this manner, the data processing device 140 may operate in a semi-autonomous manner by predicting operational anomalies that can lead to events occurring in the system based on input data from sensors in the system. The data processing device 140 may further proactively control a part of the system to prevent the occurrence of the events before they happen.

The user device 150 receives any output data from the data processing device through a network connection (e.g., a local area network connection) and provides the output data through some form of user interface to a user (e.g., an operator or technician). In some cases, the user may request information or specific data from one or more of the sensors in the sensor structure 120 or may request specific information or data based on the processing of signals and data from the following sensor or meter performed in the data processing device. Additionally, control commands may also be entered by a user through the user interface and provided to the data processing device 140, as described above. The control command may be based on reviewing outcomes of the processing, including the identification of an anomaly as described above.

In some embodiments, the output data from the edge processing device is the outcome for a result or operational characteristic of the system or device that is requested by the user. For example, the outcome may be the identification of an anomaly at a point in time in the future that is likely to cause a failure of a component, in a piece of manufacturing equipment utilizing a fluid flow system such as system 100. The outcome may be provided to the user as the number of remaining punches that can be performed before failure. Another example may be the identification of a need for maintenance on a component based on the identification of an anomaly in the operation of the component at a point in time in the future.

It is worth noting that, in some cases, the sensor interface 120, the control interface 160, and/or the user device 150 may all utilize a common local network interface. Examples of common local network interfaces include, but are not limited to, ethernet, universal serial bus (USB), Bluetooth, and the like. Additionally, the external network that is connected to the data processing device 140 may include one or more communication mediums (e.g., wired, wireless) and networks that may all be interconnected, in some cases, through the internet. Some of the networks may be private networks using proprietary network protocols while others may be public or standardized networks, such as ethernet, the institute for electrical and electronics engineers (IEEE) standard 802.11, cellular standards, 3G, 4G, or 5G, and the like.

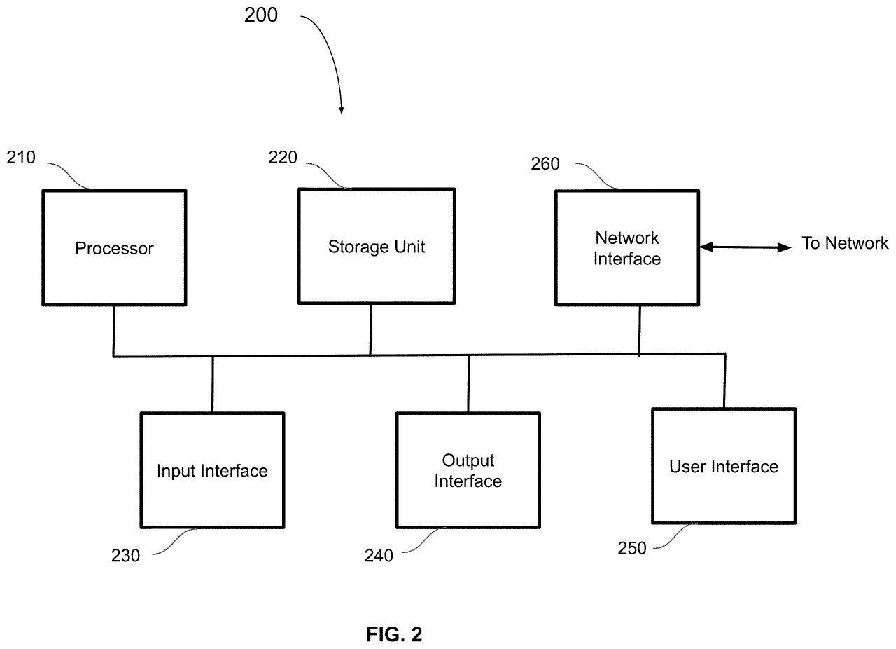

Turning to FIG. 2, a block diagram of an exemplary data processing device 200 according to aspects of the present disclosure is shown. Data processing device 200 may be used as part of a system, such as system 100 described in FIG. 1. The data processing device 200 includes a processor 210, a storage unit 220, an input interface 230, an output interface 240, and user interface 250, and a network interface 260 which are connected together electrically or otherwise coupled together by a communication bus. In some embodiments, one or more elements shown in the edge processing device of FIG. 2 may be coupled together by a mechanism other than a bus connection. It is worth noting that some elements necessary for operation of an edge processing device like that shown in FIG. 2 are not shown as they are well known to those skilled in the art.

The network interface 260 provides an interface between the data processing device 200 and a network, such as the network described in FIG. 1. Data and information may be communicated to and from processor 210 and one or more external devices connected to the network. The network interface 260 may be communicable with the network via a cable or wireless communication medium using one or more communication protocols. The communication protocols include, but are not limited to, IEEE 802.3 (Ethernet), IEEE 802.11, cellular 3G, cellular 5G, and the like.

The processor 210 controls operations of the data processing device 200. Processor 210 also receives data values, such as data values from data streams generated by one or more sensors (e.g., the sensors in sensor structure 120 in FIG. 1) through either network interface 240. Process 210 further processes the received data values and performs any computations necessary for operations associated with the functions needed to implement any of the processes used to determine anomalies in the received data values. Processor 210 additionally implements one or more machine learning algorithms to identify or predict additional data values and anomalies for points in time in the future. Processor 210 may be formed or embodied by any known and suitable hardware, or software, or a combination of hardware and software. For example, processor 210 may be formed by dedicated hardware such as a processing circuit, or by a programmable processing and arithmetic logic unit, such as a Central Processing Unit (CPU), that is used to execute a program stored in storage unit 220.

The storage unit 220 stores at least one program to be executed by the processor 210, and various data, including current and/or past data values and used as part of computations performed by the processor. The storage unit may also store intermediate data of computations performed by the processor, as well as results or data used by other elements in data processing device 200. Storage unit 220 may also store data and information received from a network through network interface 260 as well as data and information received from and provided to a user through network interface 230. The storage unit 220 may be formed or embodied using any suitable storage or means capable of storing any programs, data, or the like in a computer-readable manner. Examples of elements that may comprise the storage unit include non-transitory computer-readable storage media such as semiconductor memory devices, and magnetic, optical, or magneto-optical recording media loaded into a read and write unit. The semiconductor memory devices may include but are not limited to, RAM, ROM, Electrically-Erasable Programmable ROM (EEPROM), and flash memory.

The input interface 230 provides an interface between the data processing device 200 and a set of data sources or sensors (e.g., sensor 120) used in a system, such as system 100 described in FIG. 1. Data and information may be communicated to processor 210 from the data sources or sensors either through a direct connection or through another interface, such as sensor interface 130. The input interface 230 may include a physical interface for either a wired or wireless communication medium. The input interface 230 may be configured to use one or more of the standard communication protocols similar to those described above for network communication. In some embodiments, the communication protocol may be a proprietary protocol used specifically for the data sources or sensors.

The output interface 240 provides an interface between the data processing device 200 and one or more control elements (e.g., flow control valve 170) used in a system, such as system 100 described in FIG. 1. Information, such as control commands, may be communicated from processor 210 to the control elements through a direct connection or through another interface, such as control interface 160. The output interface 240 may include a physical interface for either a wired or wireless communication medium and configured to use standard communication protocols similar to input interface 230. In some embodiments, the output interface 240 may use a proprietary communication protocol that is specific for the control elements.

It is important to note that although input interface 230 and output interface 240 are described as configured to communicate in only one direction, in some embodiments, one or both of input interface 230 and output interface 240 may be configured to communicate bidirectionally. Bidirectional communication may allow the input interface 230 to provide requests for data made from processor 210 to the data sources or sensors. Bi-directional communication may further allow the output interface to provide an acknowledgement of receipt and/or execution of control commands generated from the control elements to be provided to processor 210. In some embodiments, one or both the data sources or sensors and the control elements may be configured to communicate over a network that is coupled to network interface 260. As such, one or both of input interface 230 and output interface 240 may not be included as part of data processing device 200.

User interface 230 may include circuitry and physical interface components for one or more input elements that may be used by a user for entering data and/or control the operation of data processing device 200. The one or more input elements include, but are not limited to a keyboard, a mouse, a trackball, microphone, a touch panel, and the like. User interface 230 may also include circuitry and physical interface components for one or more output elements that may be used by a user to retrieve and consume information received and/or processed by data processing device 200. The one or more output elements include, but are not limited to, a display unit, a speaker, a vibratory unit, and the like. In some embodiments, the user interface may also utilize common physical interfaces allowing external devices having both input and output capabilities to interface to the data processing device. The external devices include, but are not limited to, a cell phone, a tablet computer, a laptop computer, and the like.

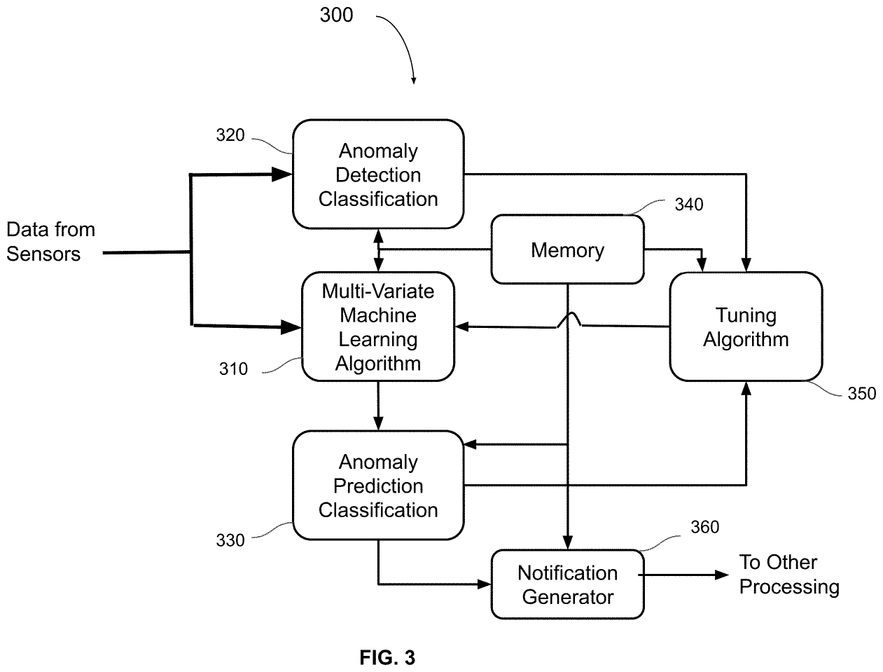

Turning to FIG. 3, a block diagram of a core processing engine 300 used in a data processing device according to aspects of the present disclosure is shown. The core processing engine may be used as part of a processor in a data processing device, such as data processing device 200 described in FIG. 2. The core processing engine 300 may also be used as part of the data processing device 140 described in FIG. 1. The core processing engine 300 may be embodied in any combination of hardware, software, or firmware. For example, the core processing engine may be created using software modules and coded into a microprocessor or microcontroller. The software modules may also be stored in a memory (e.g., storage unit 220 in FIG. 2) and loaded into a microprocessor (e.g., processor 210) as part of device initialization. Alternatively, the core processing engine 300 may be assembled using hardware configuration code (e.g., Verilog high definition language (VHDL) as part of a configurable hardware gate array device.

The core processing engine 300 includes a multivariate machine learning algorithm (MVMLA) element 310 that receives data values from a set of sensors incorporated in a sensor element associated with a component (e.g., sensor structure 120 described in FIG. 1). The MVMLA 310 is coupled to an anomaly prediction and classification (APC) element 330. The core processing engine 300 also includes an anomaly detection and classification (ADC) element 320 that also receives the data values from the set of sensors. The APC 330 and ADC 320 elements are both coupled to a tuning algorithm (TA) element 350. TA 350 is coupled back to MVMLA 310. The APC 330 is also coupled to a notification generator 360, which provides outcomes or notifications to other parts of the data processing device (e.g., data processing device 200), such as a remaining section of the processor, the user interface, or the network interface. A memory 340 is also coupled to each of the MVMLA 310, ADC element 320, APC element 330, TA 350, and notification generator 360.

In operation, a set or series of data streams representing data values from a plurality of data sources or sensors (e.g., sensor structure 120 through sensor interface 130 in FIG. 1), is provided to both MVMLA 310 and ADC 320. Each of the data values either includes a time stamp that was either part of the received data stream or was added by the processor (e.g., processor 210 in FIG. 2) in the data processing device. The MVMLA 310 applies a set of machine learning algorithms to the data values in each data stream to generate and identify a set of additional data values for points in time in the future, or beyond the current point in time, as predictive or expected data values. Each of the predictive data values also includes a time stamp similar to the data values provided to MVMLA 310. In most cases, the machine learning algorithms utilizes the current data values in each of the data streams as well as a set of past data values from each of the data streams. The past data values may be retrieved from a memory (e.g., memory 340 or storage unit 220 in FIG. 2). In some embodiments, the current data values for some or all of the set of data streams are provided to each of the machine learning algorithms used to generate the predictive data values for each of the data streams.

The ADC element 320 further processes the current data value in each of the data streams, as well as a set of past values for each of the data streams, to identify anomalous values in the data streams to generate a set of anomaly data values that can be formed into an anomaly value stream for each of the received data streams. The current value, along with the set of past values, are processed to identify anomalies in the values from the data at the current point in time for each of the set of data streams. The past values may be stored in and retrieved from a memory (e.g., memory 340 or storage unit 220 in FIG. 2).

The identified anomalies may be further classified as part of identifying or determining that an operational anomaly has occurred for the component or components associated with the data sources or sensors. In some embodiments, the classification may be further reviewed by a user (e.g., skilled technician or operator) to associate an event (e.g., a failure or other issue in the system) with one or more of the classes of identified anomalies. For example, an operational anomaly may be identified based on anomaly data values generated for the data stream received from a flow rate sensor along with anomaly data values generated for the data stream received from a pressure sensor in a sensor element (e.g., sensor element 120 in FIG. 1). The identified anomalies may be classified as a type of operational anomaly. The user may review the identified and classified operational anomaly and determine that an event has occurred in the system based on the operational anomaly. The user may associate that event with the classification of that operational anomaly. The classification and associated event may be used to identify and/or classify future operational anomalies that may be identified in ADC 320 as well as future predicted operational anomalies that may be identified in APC 330. The classification and associated event may also be used for data values received from other sensor elements that may be at other points or associated with other components in the system. The classification information, including the event associated with the classification, as well as the corresponding operational anomalies, may be stored in the memory for use as part of the classification performed in APC 330.

The predictive data values for each of the data streams from the MVMLA 310 are provided to the APC 330. The APC 330 operates in a manner similar to the ADC 320 element to generate a set of predictive anomaly data values, often referred to as expected anomaly data values, which can be formed into another anomaly value data stream, referred to as the predictive or expected anomaly value data stream. The APC 330 uses a set of predictive data values in place of the current and past values in place of the current values and the set of past values that are used in ADC 320. The past predictive values may be stored in and retrieved from a memory (e.g., memory 340 or storage unit 220 in FIG. 2). The predictive anomaly value data stream is used to identify anomalies in the predictive data values generated for the set of data streams in a manner similar to ADC 320. The APC 330 also classifies those anomalies to use in identifying an operational anomaly that will or is likely to occur at a point in time past the current point in time for the component or components associated with the data sources or sensors. The classification may include comparing the predictive anomaly data values to anomaly data values from prior operational anomaly classification identified and determined either by ADC 320 or APC 330.

If an operational anomaly is identified, the identified point in time, along with information about the operational anomaly based on the classification is provided to the notification generator 360. The notification generator 360 packages the information as a signal and provides the signal to other parts of the data processing device. In some embodiments, the signal may be an email or text message that is to be provided to an external network through a network interface (e.g., network interface 260 in FIG. 2). In some embodiments, the signal may include information to make an audible sound or display a visual indication through a user interface (e.g., user interface 250). In some embodiments, the signal may be an email or text message and may include information for audio or visual display that is provided to a user device (e.g., user device 150 in FIG. 1) connected to the data processing device.

Memory 340 may be considered a local or short term memory storage element. Memory 340 is primarily used to store predictive data values generated for each of the data streams as well as the values in the predictive anomaly value data stream to assist in time alignment to newly received current data values in the set of data streams as part of processing in TA element 350. As such, memory 340 may be embodied as some form of RAM as described above.

It is worth noting that in some embodiments one or more of the machine learning algorithms used as part of MVMLA 310 may require a training phase prior to normal operation. During the training phase the machine learning algorithm is applied to known data values, such as data values previously received, and referred to as training data. A portion of the training data is used to find operating parameters for the machine learning algorithm, such as coefficients in a polynomial or weights for values in an equation, which produce a minimum amount of error between the training data and the corresponding predictive data generated by the machine learning algorithm. In many cases, any remaining training data may be used to test the operating parameters. This process may be repeated a number of times to improve the performance of the machine learning algorithm. Other elements in the core processing engine 300 may also be used during the training phase, such as the ADC element 320, APC element 330, and the TA element 350. Further, in some cases, the training phase may be re-entered during normal operation, often referred to as re-training.

The TA element 350 may also perform some form of time alignment of values between the predictive anomalous value data stream and anomalous value data stream. The time alignment of the streams is important, particularly during an initial training phase, but also during normal operation as needed. The TA element 350 further processes the predictive anomaly value data stream along with the time aligned anomaly value data stream to generate information used to modify or replace one or more of the machine learning models in the MVMLA 310. TA element 350 provides the information back to the MVMLA 310 for application to the next currently received data values in the data streams.

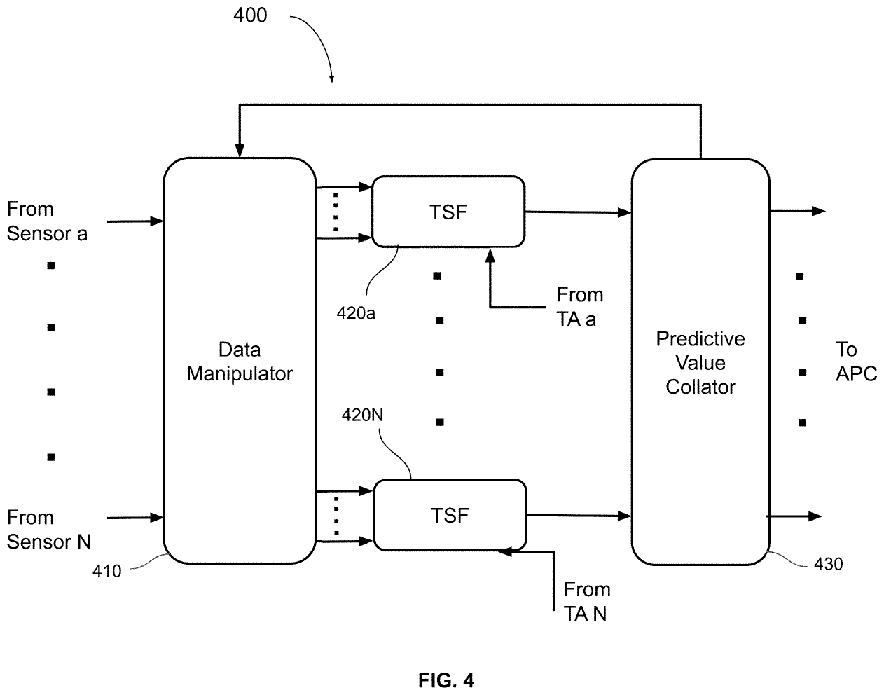

Turning to FIG. 4, a block diagram of a MVMLA 400 used as part of a core processing engine according to aspects of the present disclosure is shown. MVMLA 400 may operate in a manner similar to that described above for MVMLA 310 and may be as part of a core processing engine as described in FIG. 3. In some embodiments, MVMLA 400 is configured to use a multivariate time series forecast algorithm, referred to as a MVTSF. Other embodiments may be configured to use other algorithms including, but not limited to, long short-term memory (LSTM), autoregressive integrated moving average (ARIMA), and seasonal ARIMA (SARIMA). In MVMLA 400, data streams from a set of sensors, labeled sensor a to sensor N, are provided to data manipulation element 410. The data manipulation element 410 is coupled to each of a set of time series forecasters (TSFs) 420a-420N. Each TSF 420a-420N is coupled to a predictive value collator 430. Predictive value collator 430 provides a set of separate data streams representing the predictive data values for each of the data streams associated with the set of sensors (i.e., sensor a to sensor N) to an APC (e.g., APC 330). Predictive value collator 430 is also coupled to data manipulator element 410. Further, a connection from the TA element (e.g., TA 350) in the core processing engine is provided to each one of the TSFs 420a-420N.

It is worth noting that the number of data streams from the sensors that are associated with any component is variable and depends on several factors, including the type of component, the types of sensors that are used and the complexity of the system. In an embodiment similar to the embodiment described in system 100, eight data streams are generated from the sensors included in sensor structure 120. The sensors may be labeled sensor a to sensor h. In a similar manner the TSFs may be labeled TSF 420a-420h. In other embodiments, more or fewer sensors may be used and may generate more or fewer data streams.

The data manipulation element 410 receives and processes the incoming data streams to convert and/or transform the data values into a format that can be processed by each of the TSFs 420a-420N. For example, the data manipulation element 410 may transform raw or unformatted data values in a data stream from one or more of the sensors into sine wave values (i.e., amplitude & frequency). In some embodiments, each one of the data streams may be processed through a different transformation or conversion process in the data manipulation element 410. The transformation or conversion process for any of the data streams may be modified or replaced using information provided back from the predictive value collator 430 based on the predictive values generated by TSFs 420a-420N. In some embodiments, the transformation or conversion process may additionally be modified or replaced based on information provided back from the TA element (e.g., TA 350 in FIG. 3) as will be discussed in more detail below. In this manner, data manipulation element 410 minimizes the need for additional human involvement or assistance in assessing the types of transformations and conversions that are used in processing the received data streams from the set of sensors.

The processed data values in the data streams associated with the sensors from the data manipulation element 410 are each provided to TSF 420a-420N. TSF 420a-420N are configured to process a series of data values in time, based on the time stamps. The data values include the current time data values as well as a set of past time data values typically continuing backwards in time from the current time data value. The past time data values may be retrieved from a memory or storage unit (e.g., memory 340 or storage unit 220 in FIG. 2). The number of past time data values that are used may be predetermined based on the machine learning algorithm and/models that are used or may be selected by the user. In an embodiment, five past time data values from each stream are used. In some embodiments, the number of past time data values may be dynamically adjusted either by the TSF model or through information provided by the TA element (e.g., TA 350 in FIG. 3).

As shown, the current time data values, along with the set of previous time data values, for each of the data streams are provided to each one of TSFs 420a-420n as described above. In some embodiments, the current time and previous time data values for only a subset of the data streams may be supplied to each one of TSFs 420a-420n. In general, the data values for the data stream associated with the corresponding TSF is likely always provided. In other words, the data stream from sensor a will be provided to TSF 420a, and so on. Further, in some embodiments, the subset of data streams used to supply the current and past data values may be different for each of one of the TSFs 420a-420N. In some embodiments, the data values for the set of data streams provided to each of the TSFs 420a-420N may be weighted. In some embodiments, the set of data streams provided to each of the TSFs 420a-420N and/or the weighting of the data values for each data stream in the set of data streams may be predetermined by a user. In some embodiments, the set of data streams provided to each of the TSFs 420a-420N and/or the weighting of the data values for each data stream in the set of data streams may be determined as part of the training phase for the machine learning algorithm.

TSFs 420a-420n process the current time and previous time data values to generate or form a next time data value, referred to as a first predictive data value. That predictive data value is associated with one corresponding data stream generated from one corresponding sensor. That is, TSF 420a generates predictive data values for the data stream generated by sensor a and so on. In this manner each one of TSFs 420a-420N produces a single output, or predictive data value, based on a multivariate, multiple input data stream prediction. Depending on the machine learning model used, TSFs 420a-420N form successive predictive data values using some combination of one or more of the previous predictive data values along with some or all of the current time values and past time data values. In theory, time series forecast algorithms may continue to generate successive predictive data values forever. However for practical reasons, including diminishing accuracy of the prediction and the amount of time needed for processing, a time limit is typically established and used. In an embodiment, TSFs 420a-420N generate predictive data values at a rate of 100 times the incoming rate of data values resulting in predictive values for a time window 10 minutes beyond the current point in time. As a result, 600 future predictions are generated for each new data value received from each stream at an incoming data rate of one new data value per second. In other embodiments, predictive data rates and/or time windows may be used based on different incoming data rates and implementation and may further depend on predictive accuracy considerations. The predictive data values generated by TSFs 420a-N may be stored in a memory (e.g., storage unit 220 in FIG. 2 or memory 340 in FIG. 3).

Further, each time a new set of processed current data values are provided from data manipulator 410, each of the TSFs 420a-420N may process the new current time data values and a new set of previous time data values, including the old current time data values, to generate a new first predictive data value. The new first predictive value is at a point in time that is subsequent to the first predictive value generated above. In this manner, the predictive data values beyond the current time data values may also be constantly updated based on new data values received in the data streams, potentially operating in real time with the generation of data values from the sensors.

TSF 420a-420N may use any one or more of the various models associated with time series forecasting algorithms that are commonly employed as part of a machine learning algorithm or process. In general, the time series forecaster should include stochastic simulation that generate statistical models to describe the likely outcome of the time series in the immediate future, given knowledge of the most recent outcomes as well as alternative versions of the time series to represent what might happen over non-specific time-periods in the future. Further, in order to address the multi-variate aspects of the predictions, the statistical models may incorporate aspects of autocorrelation functions and spectral density functions as well as cross-correlation functions and cross-spectral density functions. In an embodiment, each one of TSFs 420a-420N may use a model referred to as a gradient boosting tree. In other embodiments, each one or more of TSFs 420a-420N may utilize another model and/or use different models. Further, any one of the models used by TSFs 420a-420n may be adjusted and/or replaced as a result of information provided back from the TA element (e.g., TA 350 in FIG. 3). The adjustment and/or replacement may be done as part of a training phase for the machine learning operation of the core processing engine or may be done during evaluation of the actual real time data streams, either continuously, periodically, or by request by the end user (e.g., technician or operator). The adjustment and/or replacement as a result of information from the TA element will be described in further detail below.

The set of predictive data values for each of the data streams associated with TSFs 420a-420N are provided to the predictive value collator 430. The predictive value collator 430 collects the predictive values for each of the data streams and groups them to each of their respective data streams in proper time order. The predictive value collator 430 provides the predictive data streams to the next element in the core processing element (e.g., APC element 330). The predictive value collator may further provide any additional data transformation required for the predictive data values as needed for use in the next element. The predictive value collator 430 may also provide one or more updated values used for the transformation and/or conversion of the incoming data stream to the data manipulation element based on the resulting predictive data streams from TSFs 420a-420N.

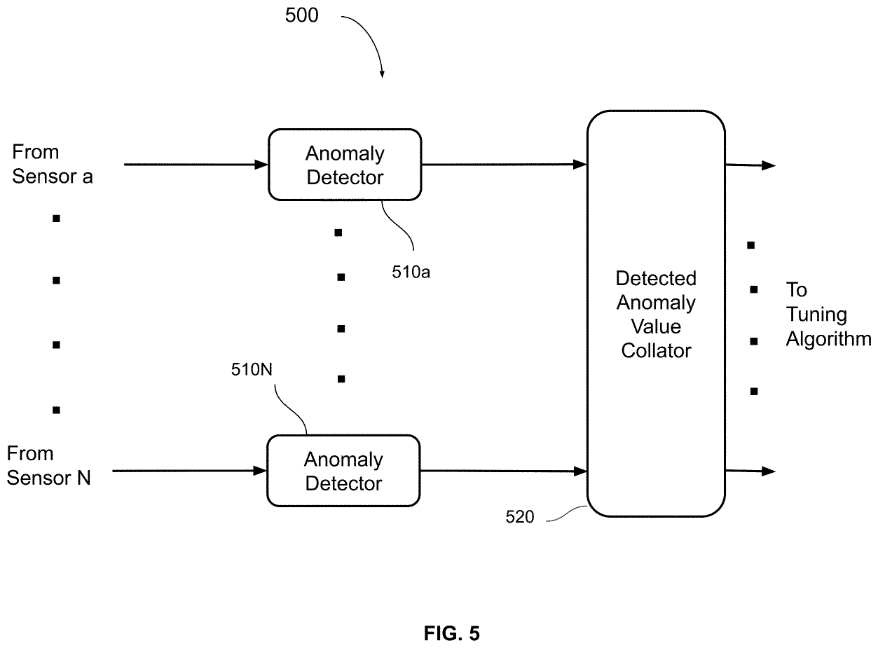

Turning to FIG. 5, a block diagram of an ADC element 500 used as part of a core processing engine according to aspects of the present disclosure is shown. The ADC element 300 may be used as part of core processing engine 300 as described in FIG. 3. In ADC element 500, data streams from a set of sensors, labeled sensor a to sensor N, as described above are provided to a respective anomaly detector 510a-510N. The anomaly detectors 510a-510N are coupled to a detected anomaly value collator 520. The detected anomaly value collator 520 provides a set of separate data streams, referred to as anomaly value data streams as described above, to a TA element (e.g., TA 350).

The anomaly detectors 510a-510N receives and processes the incoming data streams as described above to generate anomaly data values corresponding to each of the data values in the data streams. The anomaly data values may be normalized in scale allowing ease of setting an anomaly threshold level. In an embodiment, anomaly data values may be represented as digital values. For example, the anomaly data values may be binary values (e.g., a series of ones and zeroes). In other embodiments, the anomaly data values may be represented as boolean values (e.g., true/false values). In still other embodiments, more complex, analog, or multi-level representations may be used. As described above for TSFs 420a-420N, each of the anomaly detectors 410a-410N correspond to a data stream from a respective sensor (e.g., sensor a to sensor N). Unlike TSFs 420a-420N, only the one corresponding data stream is provided to each of the anomaly detectors 510a-510N. That is, the data stream from sensor a is provided to anomaly detector 510a and so on.

The anomaly detectors 510a-510N may be implemented as simple value threshold detectors but more typically utilize a more complex analysis approach based on a probability model, such as a Gaussian distribution. In some cases, anomaly detectors 510a-510N may further include multivariate adaptive statistical filtering (MASF). These approaches may compute statistics in multiple time dimensions for the data, including the context based on when in time (e.g., hour of day, etc.) the data is taken, and attempt to identify and determine if specific values or sets of values are anomalies. For example, anomaly detectors 510a-510N may utilize a relative entropy model, also referred to as a Kullback-Leibler divergence model. In other embodiments, other combinations of types of detectors and/or models may be used. It is worth noting that one or more of anomaly detectors 510a-510N may utilize a different type of detector and/model.

Each set of anomaly data values is provided to detected anomaly value collator 520. The detected anomaly value collator 520 collects the anomaly data values for each of the data streams and groups them into anomaly value data streams that are associated with each of their respective data streams in proper time order. The detected anomaly value collator 520 provides the anomaly value data streams to the next element in the core processing element (e.g., TA 350). The detected anomaly value collator 520 may also provide any additional data transformation required for the predictive data values as needed for use in the next element. It is worth noting that the detected anomaly value collator 520 may also include the capability to classify operational anomalies for the component associated with one or more of the sensors based on identifying data values in the anomaly value data streams that exceed an anomaly value threshold as described above. The detected anomaly value collator 520 may further provide one or more of the anomaly data values for each of the anomaly value data streams along with any classification information to a memory (e.g., memory 340 in FIG. 3) in the core processing engine.

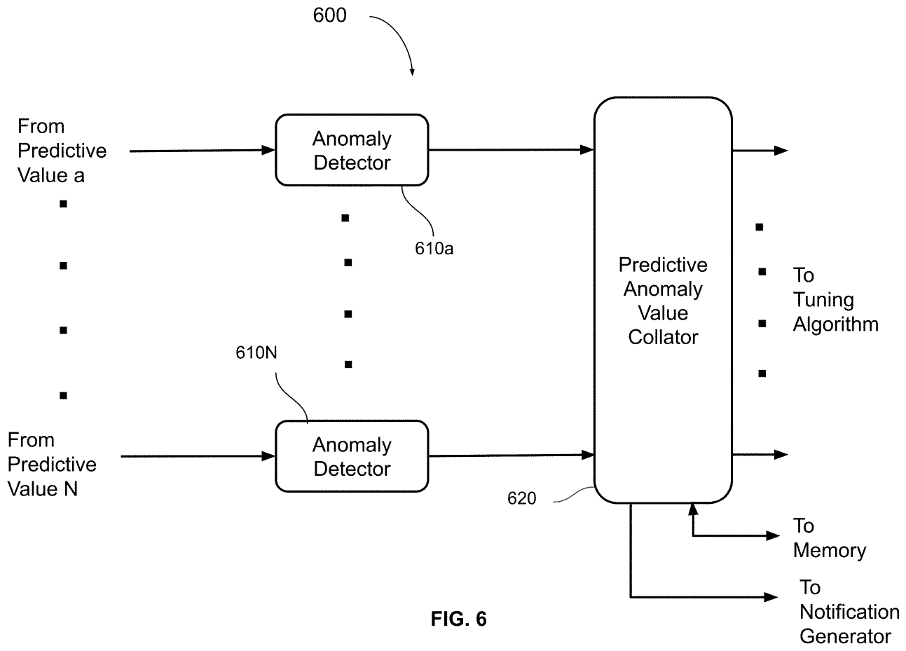

Turning to FIG. 6, a block diagram of an APC element 600 used as part of a core processing engine according to aspects of the present disclosure is shown. The APC element 600 may be used as part of core processing engine 300 as described in FIG. 3. In APC element 600, the predictive data values associated with each of the data streams from the set of sensors and generated in an MVMLA, (e.g., MVMLA 400 in FIG. 4), labeled predictive value a to predictive value N, are provided to a respective anomaly detector 610a-610N. The anomaly detectors 610a-610N are coupled to a predictive anomaly value collator 620. The detected anomaly value collator 620 provides a set of separate data streams, referred to as predictive anomaly value data streams as described above, to a TA element (e.g., TA 350). Except as described here, the structure and operation of APC element 600 is the same as described above for ADC element 500.

The anomaly detectors 610a-610N receive the corresponding data stream containing the predictive data values generated in TSF 410a-410N respectively as described above. Each of the anomaly detectors 610a-610N processes the corresponding data stream to generate predictive anomaly data values corresponding to each of the predictive data values in the data stream. The anomaly detectors 610a-610N may be implemented as simple value threshold detectors or utilize a more complex analysis approach based on a probability model and may further use statistical filtering, as described above in FIG. 5. Additionally, the predictive anomaly data values may be represented as binary values or have multiple levels of values, similar to that described above. Further, in some embodiments, one or more of the anomaly detectors 610a-610N may be different from the corresponding anomaly detectors 510a-510N described in FIG. 5.

Each set of predictive anomaly data values is provided to predictive anomaly value collator 620. The predictive anomaly value collator 620 packages the predictive anomaly data values and provides the data values as a set of predictive anomaly value data streams corresponding to each of the set of predictive data streams generated by the MVMLA (e.g., MVMLA 4000 in FIG. 4) to the TA element (e.g., TA 350 in FIG. 3) in proper time order. The predictive anomaly value collator 620 provides the predictive anomaly value data streams to the next element in the core processing element (e.g., TA 350). The predictive value collator 620 may also provide any additional data transformation required for the predictive data values as needed for use in the next element. The predictive anomaly value collator 620 may further provide all or some of the predictive anomaly data values generated by anomaly detectors 610a-610N to a memory (e.g., memory 340 in FIG. 3) in the core processing engine.

Similar to FIG. 5, the predictive anomaly value collator 620 may also include the capability to classify operational anomalies for the component associated with one or more of the sensors based on identifying predictive data values in the predictive anomaly value data streams that exceed an anomaly value threshold. These operational anomalies will be predictive in that have not yet occurred but will or are likely to in the future or at a point in time beyond the current point in time. If a classified operational anomaly is identified, information associated with the operational anomaly may be provided from the predictive anomaly value collator 620 to a notification mechanism (e.g., notification generator 360 in FIG. 3) in order to alert the user that an operational anomaly may occur that may lead to an event (e.g., a failure) in the future. In some embodiments, the user may then take action to prevent or mitigate the effect of the operational anomaly. In some embodiments, the predictive anomaly value collator 620 may classify anomalies as operational anomalies that have not been previously identified from any of the received data values in the data streams. In these instances, the newly identified classification may be provided to the user. The predictive anomaly value collator 620 may further provide information associated with the classification and notification to a memory (e.g., memory 340 in FIG. 3) in the core processing engine.

It is worth noting that, as described above, the structure and operation of the APC element 600 described in FIG. 6 and the ADC element 500 described in FIG. 5 are very similar. The main difference is that the ADC element 500 processes values from the received data streams while the APC element 600 processes values from the predictive data streams. As a result, the ADC element 500 produces a stream that can be used to identify anomalies in actual data that can be used to further identify operational anomalies in a component that have already occurred. The APC element 600 produces a stream that can be used to identify anomalies in predictive data that can be used to further identify operational anomalies that have not yet occurred. Due to their very similar structure and operation, in some embodiments, one or more of the elements used in the ADC element 500 and APC element 600 may be combined and/or shared as part of further simplification of the core processing engine, provided that some form of multiplexing can be configured and utilized.

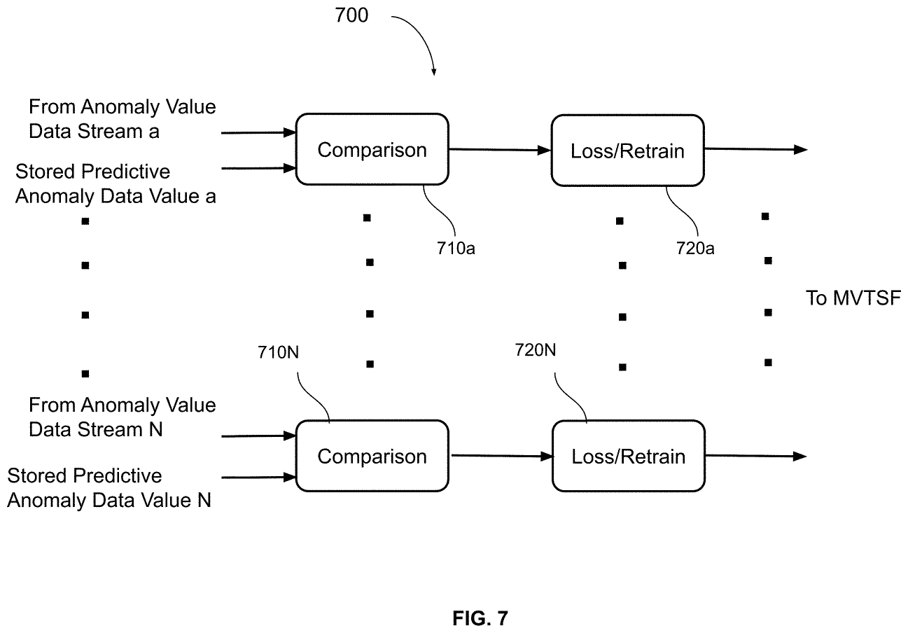

It is also worth noting that the predictive anomaly value data stream generated by APC element 600 may not match the anomaly value data stream generated by ADC element 500, even after the data values corresponding to the points in time for the predictive data have been received by the data processing device (e.g., data processing device 200). The presence of a match between the predictive anomaly value data stream and the anomaly value data stream represents the opportunity for identification of anomalies which may be false anomalies. Anomalies identified in the anomaly value stream may be recognized as false anomalies after the fact when further evaluated by a technical professional or expert. The classification of anomalies identified from the anomaly value data stream may be used to assist in the classification of anomalies identified in the predictive anomaly value data stream in order to reduce the identification of false anomalies. Further, by comparing the anomaly value data stream to the predictive anomaly value data stream and using the results to modify the MVMLA 400, as will be described in FIG. 7, the identification of false anomalies may be further reduced. An example of a comparison between the anomalies identified by each of an exemplary ADC element 500 and APC element 600 in a core processing engine, such as the core processing engine in FIGS. 3-7 will be described in further detail below.

Turning to FIG. 7, a block diagram of a TA element 700 used as part of a core processing engine according to aspects of the present disclosure is shown. The TA element 700 may be used as part of a core processing engine as described in FIG. 3. In TA element 700, anomaly data values from each of the anomaly value data streams, labeled anomaly data value data stream a to anomaly value data stream N, are provided from an ADC element (e.g., ADC 500 described in FIG. 5) to comparison elements 710a-710N. Further, the predictive anomaly data values that correspond in time with the anomaly data values in the value data streams, labeled predictive anomaly data value a to predictive anomaly data value N, are retrieved from the memory (e.g., memory 340 in FIG. 3) and also provided through the predictive anomaly value collator (e.g., predictive anomaly value collator 620 in FIG. 6) to comparison elements 710a-710N. Each of comparison elements 710a-710N is coupled to a corresponding loss/retrain element 720a-720N. Each of the loss/retrain elements 720a-720N provides information back to an MVMLA (e.g., in MVMLA 310) to adjust, modify, or replace the operational characteristics of the MVMLA. More specifically, each of the loss/retrain elements 720a-720N provides information back to a corresponding TSF (e.g., TSF 420a-420N in FIG. 4).

The comparison elements 710a-710N verify time alignment between the anomaly data values, associated with the data values actually currently received, and the predictive anomaly data values, associated with predictive values previously generated. If a time alignment error is identified, a command may be generated that includes a request to retrieve different predictive anomaly data values through a communication interface (not shown) between the TA element 700 and the APC 600. Once time alignment is verified, comparison elements 710a-710N process the inputs to compare the anomaly data values to the predictive anomaly data values to generate loss values for each point in time the comparison is made. The loss values provide an indication of the amount of divergence between the predictive anomaly data values and the anomaly data values. Loss values may be calculated based on previously generated anomaly predictions and may depend on the models used and/or one or more tolerance values. For example, loss values may be computed by applying eigen matrices or distance matrices to the predictive anomaly data values and the anomaly data values and determining distance vectors, otherwise referred to as eigen distances. Other techniques for computing the loss values are also possible. The tolerance values may be predetermined, may be set by a user, or may be programmed dynamically.

The loss values from each of the comparison elements 710a-710N are provided to the loss/retrain elements 720a-720N. Loss/retrain elements 720a-720N determine if one or more of the loss values exceed a loss value threshold. If one or more of the loss values exceed the loss value threshold, the current set of received data values and in some cases, the associated anomaly data values are stored in a memory (e.g., memory 340 or storage unit 220 in FIG. 2) as an event (e.g., a failure) in the system. Further, loss/retrain elements 720a-720N may initiate a retraining of the MVMLA (e.g., MVMLA 310 in FIG. 3) using the current set of received data values. The result of the retraining may be a set of new parameter values in the existing model or the introduction of a new model for one or more of the machine learning algorithms (e.g., TSFs 420a-420N in FIG. 4) in the MVMLA. For example, if an anomaly occurs that is not predicted during processing in the MVMLA, a new model may be introduced and trained using the received data value received over the most recent period of time (e.g., the last 60 minutes of received data values). Additionally, in some cases, new or additional data transformations and/or sets of conversion parameters may be provided to the data manipulation element (e.g., data manipulator 410) in the MVMLA. Examples of additional transformations include, but are not limited to, converting data values to a series of sine waves, converting absolute values to delta values, and the like.

It is worth noting that although the description of the core processing engine in FIGS. 3 to 7 has been based on a self-supervised technique or mechanism, the core processing engine, and specifically the TA element described in FIG. 7 may be modified to some interaction with and assistance from a user in order to further improve the predictions.

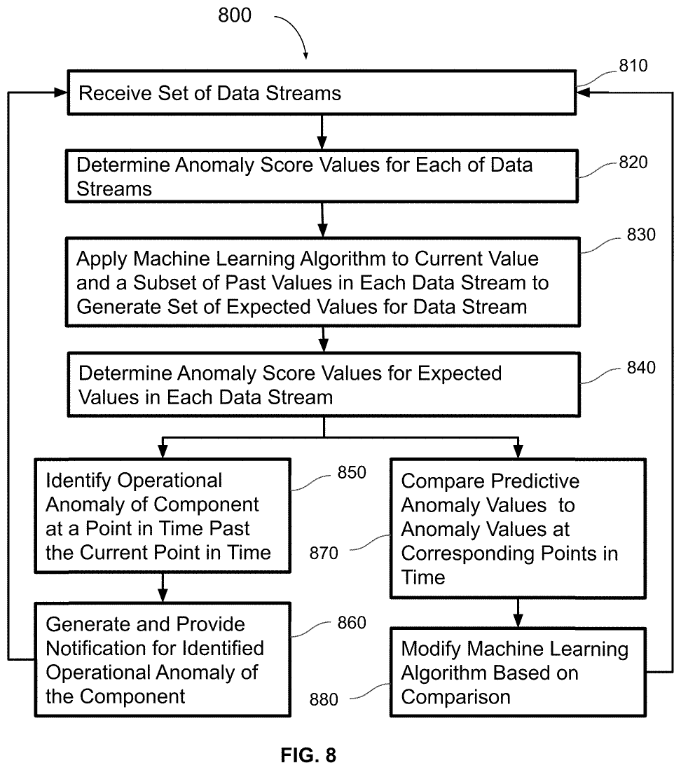

Turning to FIG. 8, a flow chart of an exemplary process 800 for predicting anomalies in a system according to aspects of the present disclosure is shown. Process 800 will be primarily described with respect to the data processing device 200 described in FIG. 2. One or more aspects of process 800 may be performed by a core processing engine included in a processing device, such as core processing engine 300 described in FIG. 3. One or more aspects of process 800 may also be performed by a computer or processing device as part of a system that includes sensor and control capabilities, such as the system 100 described in FIG. 1. Although process 800 depicts steps performed in a particular order for purposes of illustration and discussion, the operations discussed herein are not limited to any particular order or arrangement. One skilled in the art, using the disclosure provided herein, will also appreciate that one or more of the steps of process 300 may be omitted, rearranged, combined, and/or adapted in various ways.

At step 810, a set of data streams is received. The set of data streams may be provided from one or more sensors associated with, and/or coupled to, a component in a system (e.g., system 100 described in FIG. 1). The set of data streams may be received through an input interface (e.g., input interface 230) or over a network through a network interface (e.g., network interface 260). Each one of the data streams includes data values generated by the sensor(s) and associated with the operation of the component in the system at different points in time. In some embodiments, the data values in each data stream may be received, at step 810, periodically. For example, the data values may be received at a rate of one value per second in each data stream, or at a rate of one hertz (Hz)

At step 820, an anomaly data value is generated for each of the received data values in each data stream. The generation of the anomaly data value may be performed in a processor (e.g., processor 210). The anomaly data value may be generated using the currently received data values as well as a set of previously received data values as described above. In some embodiments, the generation of the anomaly data value may be performed in an anomaly detection and/or classification component (e.g., ADC 320 in FIG. 3) used in a core processing engine included in a processor. The anomaly data value may be generated, at step 820, utilizing simple threshold detectors or may utilize more complex model based detectors as described above. In an embodiment, the anomaly data value may be generated, at step 820, using a relative entropy model on each of the received data values. In some embodiments, one or more of the detectors used in generating the anomaly data value for each of the received data values in each data stream may be different. Further, in some embodiments, the anomaly data value may be a binary value.

In some embodiments, the generation of an anomaly data value, at step 820, may further include classifying the anomaly data values to identify operational anomalies that have occurred in the system, such as a performance issue or a failure with a component included in the system. The classification information may be stored in a memory (e.g., storage unit 220 or memory 340 in FIG. 3) and used in conjunction with the generation of a predictive anomaly data value described below.

At step 830, one or more machine learning algorithms are applied to the data values received at a current point in time and a subset of data values previously received for each data stream. The machine learning algorithms process the currently received data values and the subset of previously received data values to generate a set of expected or predictive data values at additional points in time, including points in time in the future or beyond the current point in time, for each data stream. The application of the machine learning algorithm(s) may be performed in a processor (e.g., processor 210). In some embodiments a set of machine learning algorithms may be used. In some embodiments, the application of a set of machine algorithms may be performed as part of multivariate machine learning structure (e.g., MVMLA 310 in FIG. 3) used in a core processing engine included in a processor as described above.

In some embodiments, one or more of the machine learning algorithms may utilize at least one time series forecasting model. In some embodiments, either the machine learning algorithms being applied, or the time series forecasting models utilized for one or more of the data streams received, at step 810, may be different. For example, a machine learning algorithm that utilizes a first time series forecasting model may be applied to the received data values at a current point in time and a subset of data values previously received for a first data stream in the set of data streams to generate a set of expected data values for the first data stream. Further, a machine learning algorithm that utilizes a second time series forecasting mode that is different from the first model may be applied to the received data values at a current point in time and a subset of data values previously received for a second data stream in the set of data streams to generate expected data values for the second data stream.

At step 840, an expected anomaly data value is generated for each of the expected data values in each data stream. The generation of the expected anomaly data value may be performed in a processor (e.g., processor 210). In some embodiments, the generation of the expected anomaly data value may be performed in an anomaly prediction and/or classification component (e.g., APC 330 in FIG. 3) used in a core processing engine included in a processor. In some embodiments, the expected anomaly data value for each of the expected data values in each data stream may be stored in a memory (e.g., storage unit 220 or memory 340 in FIG. 3). As in step 820, the expected anomaly data value may be generated, at step 840, utilizing simple threshold detectors or may utilize more complex model based detectors as described above. In an embodiment, the expected anomaly data value may be generated, at step 840, using a relative entropy model on each of the received data values. In some embodiments, one or more of the detectors used in generating the expected anomaly data value for each of the expected data values in each data stream may be different. Further, in some embodiments, the expected anomaly data value may be a binary value.

In some embodiments, the generation of an expected anomaly data value, at step 840, may further include classifying the expected anomaly data values. The classification may be used to identify operational anomalies that are likely to occur in the system in the future as described below.

At step 850, an operational anomaly for the component is identified at a point in time in the future or beyond the current point in time based on the expected anomaly data value for each of the expected data values in each data stream. In some embodiments, the identification may be based on a classification of expected anomaly data values that may be performed at step 840. The identification may further be based on the classification and identification of operational anomalies that have already occurred as may be performed at step 820 and further have led to events in the system (e.g., failures). The identification of the operational anomaly may be performed in a processor (e.g., processor 210). In some embodiments, the identification of the operational anomaly may be performed in an anomaly prediction and/or classification component (e.g., APC 330 in FIG. 3) used in a core processing engine included in a processor.

At step 860, a notification is generated for the identified operational anomaly that may lead to an event in the system (e.g., a failure). The notification may be provided to a user (e.g., technician or operator) through a user interface (e.g., user interface 250). The notification may also be provided through an electronic communication (e.g., text, email) provided to a user device (e.g., user device 150 in FIG. 1) over a network through a network interface (e.g., network interface 260). It is worth noting that in some embodiments, the notification may be provided to another part of the processor (e.g., processor 210) in order to generate a control command and provide the control command to an element or component in the system as described above. After step 860, process 800 returns to step 810 to receive the next data values in the set of data streams. It is worth noting that if no operational anomalies are identified, at step 850, process 800 may also return to step 810 after step 850.

At step 870, the expected anomaly data values for each of the expected data values for each data stream are compared to the anomaly data values for each of the received data values in each data stream at corresponding points in time. The comparison may be performed in a processor (e.g., processor 210). In some embodiments, the comparison may be performed in a tuning component (e.g., TA 350 in FIG. 3) used in a core processing engine included in a processor. In some embodiments, the comparison, at step 870, may further include retrieving the expected anomaly data values for each of the expected data values in each data stream at the corresponding points in time to the anomaly data values for each of the received data streams. In some embodiments, the comparison, at step 870, may further include generating a loss value as a result of the comparison at each of the corresponding points in time.

At step 880, one or more of the machine learning algorithms are modified based on the comparison. The modification may be performed in a processor (e.g., processor 210). In some embodiments, the modification may be generated in a tuning component (e.g., TA 350 in FIG. 3) and provided for implementation to the muti-variate machine learning structure (e.g., MVMLA 310 in FIG. 3) used in a core processing engine included in a processor. In some embodiments, modifying the machine learning algorithms, at step 880, may include retraining one or more of the machine learning algorithms if the loss value, generated at step 870, exceeds a threshold loss value. In some embodiments, modifying the machine learning algorithm, at step 880, may include modifying one or more parameters of a time series forecasting model used as part of the machine learning algorithms if the loss value, generated at step 870, exceeds a threshold value. After step 880, process 800 returns to step 810 to receive the next data values in the set of data streams.

It is worth noting that one or more of the steps of process 800 may be modified, steps may be added or omitted depending on a specific embodiment. In some embodiments, the comparison, at step 870, and the modifying, at step 880, may not be necessary or used and may be omitted. Additionally, after step 880, process 800 may return to step 830, instead of step 810, to apply the modified machine learning algorithm to the current value and a subset of past values as described above. Further, generating an anomaly data value, at step 820, may be done at the same time as, or after, applying the machine learning algorithms, at step 830.

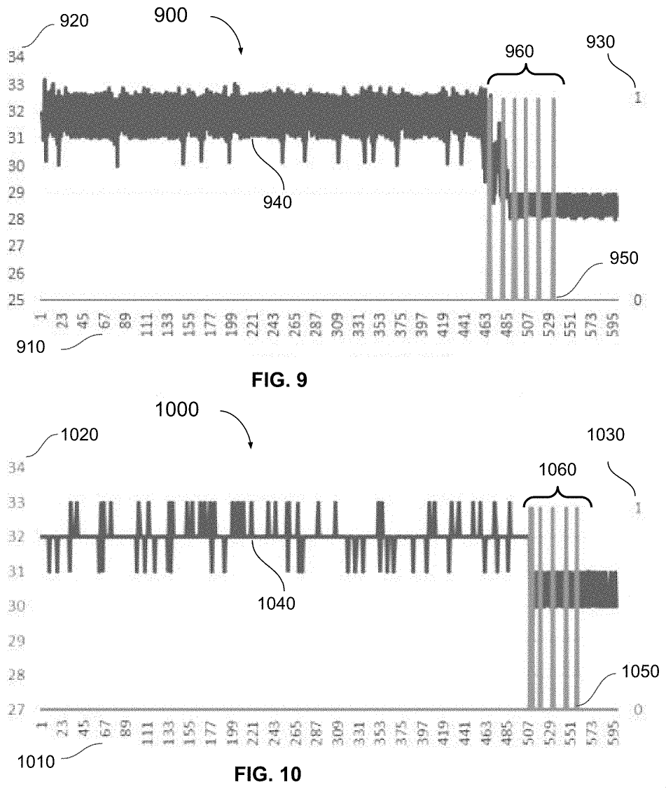

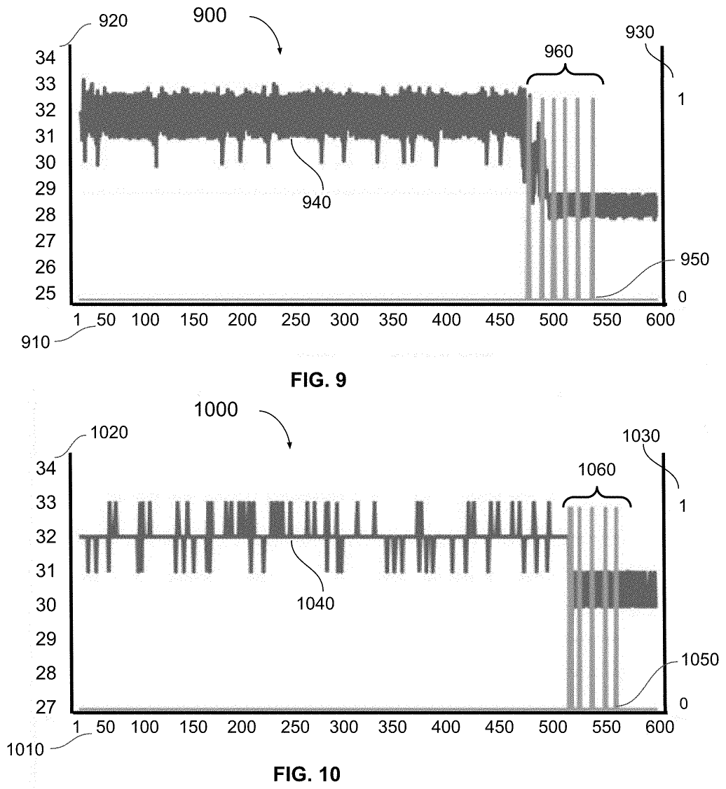

Turning now to FIGS. 9 and 10, a set of graphs 900 and 1000 comparing the predictive data values for the received data values as processed by core processing engine, such as core processing engine 300 described in FIG. 3, according to aspects of the present disclosure is shown. Specifically, graph 900 illustrates the predictive or expected data values for one data stream, along with the predictive or expected anomaly data values for that data stream, generated in the core processing engine based on received data values data streams. Graph 1000 illustrates the received data values for the same data stream that correspond in time to the predictive data values illustrated in graph 900 after they have been received by the core processing engine and the anomaly data values generated in the core processing engine for those received data values. It is worth noting that graphs 900 and 1000 display data values that have previously been received but are being processed as if it was being received in real time. As such, the machine learning algorithms in the core processing engine have processed five hours of data values received prior to the data values displayed in graphs 900 and 1000 as part of a training phase.

Graph 900 and graph 1000 each include an x-axis 910, 1010 displaying a time scale in seconds from 0 seconds to 600 seconds, or 10 minutes. For graph 900, x-axis 910 displays time as the current time (0 seconds) to 600 seconds beyond the current point in time or into the future. For graph 100, x-axis 910 displays a 600 second range of time for the last 600 seconds of received data values. Graph 900 and graph 1000 each also include a y-axis 920, 1020 on the left hand side of graph 900, 1000 displaying a value range for liquid flow rate in liters per minute (ltr/min). Graph 900 and graph 1000 each further include a y-axis 930, 1030 on the left hand side of graph 900, 1000 displaying a value range for binary data (e.g., 0 and 1).

Graph 900 includes a signal 940 representing the predictive data values generated by a MVMLA (e.g., MVMLA 310 in FIG. 3 or MVMLA 400 in FIG. 4) for a data stream generated from a sensor that monitors flow rate in a component based on current and past received data values from a set of data streams from sensors associated with a sensor element (e.g., sensor element 120 in FIG. 1). The data values that represent the current time for the starting point of the generation of the predictive values is at 0 seconds and signal 940 contains 600 predicted data values to 600 second beyond the starting point based on a 1 Hz received data rate. Graph 900 also includes a signal 950 representing predictive anomaly data values generated by an APC (e.g., APC 330 in FIG. 3 or APC 600 in FIG. 6) using the predictive data values generated above.

Graph 1000 includes a signal 1040 representing the data values for a data stream generated from the sensor that monitors flow rate, as described above, and received at the core processing engine (e.g., core processing engine 300 in FIG. 3). The received data values correspond in time to each of the predictive data values included in signal 940 above. In other words, a mapping is performed to align the first predicted data value from signal 940 with a data value received at the same corresponding point in time, at least 599 second ago in real time, from signal 1040. Graph 1000 also includes a signal 1050 representing anomaly data values generated by an ADC (e.g., ADC 330 in FIG. 3 or ADC 500 in FIG. 5) using the received data values displayed in signal 1040. As described above, the predictive data values, along with the predictive anomaly data values may be stored in a memory (e.g., storage unit 220 in FIG. 2 or memory 340 in FIG. 3) in order to facilitate the time mapping of signals 940 and 950 to signals 1040 and 1050 respectively.

In graph 900, a set of data points in signal 950 having predictive anomaly data values equal to one are highlighted in range 960. Graph 1000 also has a set of data points in corresponding graph 1050 having data values equal to one and highlighted in range 1060. The range 1060 in graph 1000 represents the identification of an operational anomaly, a significant reduction in flow rate. for the component associated with the sensor element (e.g., sensor element 120 in FIG. 1) based on processing actual received data values from the sensor element. The range 960 in graph 900 represents the same identification of the operational anomaly as predicted based on generating predictive data values and predictive anomaly data values spanning the same period of time that the operational anomaly occurs. The operational anomaly may further have been classified and related to a fluid leak in the component or a section of the piping (e.g., pipe 110 in FIG. 1). The presence of the fluid leak may result in a failure of the component or other parts of the system. The predictive data values have determined that an operational anomaly will occur 463 seconds beyond the current time that the predictive data values were generated. As a result, some form of action, such as notifying the user of the operational anomaly. The user may then take corrective action before the failure occurs.

It is worth noting that the time of the occurrence of the operational anomaly highlighted by range 960 is different from the time of the occurrence highlighted by range 1060. The difference may not be considered significant and is likely due to the large time span between the starting time for the generation (i.e., 0 secs) of the predictive data values and range 960 (i.e., 463-530 secs). As additional data values are received closer to the actual occurrence of the operational anomaly, the generation of the predictive data values in that time range will become increasingly more accurate. Further, it is worth noting that data values from each of eight sensors monitoring flow rate of the fluid, voltage of the sensor, current drawn by the sensor, temperature of the fluid, temperature of the sensor, pressure of the fluid, acceleration of the sensor in a first direction and acceleration of the sensor in a second direction as described above in FIG. 1 were provided to each of the MVMLAs (e.g., MVTSFs 420a-420N in FIG. 4). Additional processing experiments using less than all eight sensors did not consistently provide the predictive data values needed to predict the occurrence of the operational anomaly at all or predict the occurrence near the correct time range. It is also worth noting that the results illustrated by graph 900 and 1000 may be further improved by processing a comparison of the predictive anomaly data values in signal 950 and the anomaly data values in signal 1050 in tuning element (TA 350 in FIG. 3 or TA 700 in FIG. 7) to further modify one or more of the MVLMAs (e.g., MVTSFs 420a-420N in FIG. 4) as described earlier.

It is to be appreciated that although the embodiments described above focus on physical hardware and elements within a system, such as a manufacturing system, the principles of the present disclosure may be easily extended to implementations that involve software based programming that are stored in a computer readable medium, such as a magnetic optical based storage structure. Further, in some embodiments, one or more of the elements of a process based on the principles of the present disclosure, such as process 800 described above, may be implemented utilizing cloud-based operations and/or storage. It is also to be appreciated that, except where explicitly indicated in the description above, the various features included as part of the principles of the present disclosure can be considered cumulative and interchangeable, that is, a feature shown in one embodiment may be incorporated into another embodiment.

Although embodiments which incorporate the teachings of the present disclosure have been shown and described in detail herein, those skilled in the art can readily devise many other varied embodiments that still incorporate these teachings. Having described preferred embodiments of an apparatus and method for predicting anomalous events in a process, it is noted that modifications and variations can be made by persons skilled in the art in light of the above teachings. It is therefore to be understood that changes may be made in the particular embodiments of the disclosure which are within the scope of the disclosure.

1. A method comprising:
receiving a set of data streams, each data stream including data values generated by a sensor associated with the operation of a component in a system at points in time;
generating an anomaly data value for each of the received data values in each data stream;
applying at least one machine learning algorithm to the data values received at a current point in time and a subset of data values previously received for each data stream to generate expected data values at additional points in time beyond the current point in time for each data stream;
generating an expected anomaly data value for each of the expected data values in each data stream; and
identifying an operational anomaly for the component at a point in time beyond the current point in time based on the expected anomaly data value for each of the expected data values in each data stream.

2. The method of claim 1, further including providing a notification about the identified operational anomaly to a user.

3. The method of claim 1, further comprising:
comparing the expected anomaly data value for each of the expected data values for each data stream to the anomaly data value for each of received data values in each data stream at a corresponding point in time; and
modifying the machine learning algorithm based on the comparison.

4. The method of claim 3, wherein comparing the expected anomaly data value for each of the expected data values to the anomaly data value for each of received data values includes generating a loss value as a result of the comparison at the corresponding point in time.

5. The method of claim 4, wherein modifying the machine learning algorithm includes retraining the machine learning algorithm if the loss value exceeds a threshold value.

6. The method of claim 4, wherein the at least one machine learning algorithm utilizes a time series forecasting model and wherein modifying the machine learning algorithm includes modifying at least one parameter of the time series forecasting model if the loss value exceeds a threshold value.

7. The method of claim 3, further including:
storing the expected anomaly data value for each of the expected data values in each data stream; and
retrieving the expected anomaly data value for each of the expected data values at the corresponding point in time.

8. The method of claim 1, wherein generating an expected anomaly data value for each of the expected data values in each data stream includes utilizing a relative entropy model on each of the expected data values.

9. The method of claim 1, wherein the expected anomaly data value is binary.

10. The method of claim 1, wherein the data values in each data stream are received periodically.

11. The method of claim 11, wherein applying a machine learning algorithm further includes applying a machine learning algorithm utilizing a first time series forecasting model to the received data values at a current point in time and a subset of data values previously received for a first data stream to generate expected data values for the first data stream and applying a machine learning algorithm utilizing a second time series forecasting model to the received data values at a current point in time and a subset of data values previously received for a second data stream in the set of data streams to generate expected data values for the second data stream, the second time series forecasting model being different from the first time series forecasting model.

12. An apparatus comprising;
an input interface that receives a set of data streams, each data stream including data values generated by a sensor associated with the operation of a component in a system at points in time; and
a processor coupled to the input interface, the processor configured to:
determine an anomaly data value for each of the received data values in each data stream;
apply a machine learning algorithm to the received data values at a current point in time and a subset of data values previously received for each data stream to generate expected data values at additional points in time past the current point in time for each data stream;
determine an expected anomaly data value for each of the expected data values for each data stream; and
identify an operational anomaly of the component at a point in time past the current point in time based on the expected anomaly data value for each of the expected data values for each data stream.

13. The apparatus of claim 12, further including an output interface coupled to the processor, the output interface providing a notification about the identified operational anomaly to a user.

14. The apparatus of claim 12, wherein the processor is further configured to:
compare the expected anomaly data value for each of the expected data values for each data stream to the anomaly data value for each of received data values in each data stream at a corresponding point in time; and
modify the machine learning algorithm based on the comparison.

15. The apparatus of claim 14, wherein comparison of the expected anomaly data value for each of the expected data values to the anomaly data value for each of received data values further includes generating a loss value as a result of the comparison at the corresponding point in time.

16. The apparatus of claim 15, wherein the processor is further configured to retrain the machine learning algorithm if the loss value exceeds a threshold value.

17. The apparatus of claim 15, wherein the at least one machine learning algorithm utilizes a time series forecasting model and wherein the processor is further configured to modify at least one parameter of the time series forecasting model if the loss value exceeds a threshold value.

18. The apparatus of claim 14, further including a memory coupled to the processor, the memory storing the expected anomaly data value for each of the expected data values in each data stream and retrieving the expected anomaly data value for each of the expected data values at the corresponding point in time.

19. The apparatus of claim 12 , wherein the processor is further configured to generate the expected anomaly data value for each of the expected data values in each data stream utilizing a relative entropy model on each of the expected data values.

20. A non-transitory computer readable medium having stored thereon instructions that, when executed by at least one processor, perform the steps of:
receiving a set of data streams, each data stream including data values generated by a sensor associated with the operation of a component in a system at points in time;
generating an anomaly data value for each of the received data values in each data stream;
applying at least one machine learning algorithm to the data values received at a current point in time and a subset of data values previously received for each data stream to generate expected data values at additional points in time beyond the current point in time for each data stream;
generating an expected anomaly data value for each of the expected data values in each data stream; and
identifying an operational anomaly for the component at a point in time beyond the current point in time based on the expected anomaly data value for each of the expected data values in each data stream.
